(19) United States
(12) Patent Application Publication
(10) Pub. No.: US 2026/0081820 A1
(43) Pub. Date: Mar. 19, 2026

(54) INTELLIGENT TRAFFIC ROUTING SYSTEM

(71) Applicant: T-MOBILE INNOVATIONS LLC, Overland Park, KS (US)

(72) Inventors: Henry Pradeep Kumar CYRIL, Bothell, WA (US); Manoj LAKUMARAPU, Overland Park, KS (US)

(21) Appl. No.: 18/885,334

(22) Filed: Sep. 13, 2024

(51) Int. Cl. H04L 41/0663; H04L 45/28

(52) U.S. Cl. CPC H04L 41/0663; H04L 45/28

(57) ABSTRACT

Embodiments of the present disclosure are directed to systems and methods for routing traffic to back-up clusters within a wireless communication system. A network provisioning engine (NPE) resumes an in-progress transaction at a standby site in an active hot standby (AHS) setup. As such, the present disclosure is directed to a proactive method of traffic routing in which an AHS setup is used in conjunction with an NPE. The present disclosure also detects and identifies system issues to trigger failover in real-time or near real-time. Every NPE includes a set of clusters. Every cluster being processed at a first data center is paired up with the same set of clusters (e.g., back-up clusters) at a second data center to ensure that geographic redundancy is maintained. When the first data center experiences a disruption, the second data center picks up with processing the transaction where the first data center left off.

### SUMMARY

The present disclosure is directed to routing traffic to back-up clusters within a wireless communication system, substantially as shown and/or described in connection with at least one of the Figures, and as set forth more completely in the claims.

According to various aspects of the technology, a network provisioning engine (NPE) resumes an in-progress transaction at a standby site in an active hot standby (AHS) setup. As such, the present disclosure is directed to a proactive method of traffic routing in which an AHS setup is used in conjunction with an NPE. The present disclosure detects and identifies system issues in real-time or near real-time to trigger failover in real-time or near real-time. According to the disclosure described herein, the NPE includes a set of clusters that serve brands (e.g., a customer plan associated with a telecommunications network). Each NPE cluster includes multiple components (e.g., inbound adapter, orchestrator, outbound adapter, catalog, database, etc.). When components of the clusters are operating properly, the customer receives the full services associated with the brand that is associated with the customer. Every NPE cluster being processed at a first data center is paired up with the same set of NPE clusters (e.g., back-up clusters) at a second data center to ensure that geographic redundancy is maintained. Here, the first data center includes a first NPE and is the primary data center that is active and receives the traffic, and the second data center replicates the first NPE with a second NPE that is held in standby, only to be enabled when it is determined that the first NPE may experience a disruption. In case any of the components within a cluster being processed by the first NPE is determined to fail or potentially fail while processing a transaction, the transaction may resume at the second data center with the second NPE. Because the second data center is synced with the first data center, the second data center may pick up with processing the transaction at the point where the first NPE failed or may have failed. In this way, processing the transaction continues in real-time or near real-time.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates a computing device for use with the present disclosure;

FIG. 2 illustrates a network environment in which implementations of the present disclosure may be employed;

FIG. 3 illustrates a network provisioning engine in which implementations of the present disclosure may be employed;

FIG. 4 illustrates clusters of the network provisioning engine in which implementations of the present disclosure may be employed;

FIG. 5A illustrates provisioning requests from the network provisioning engine of network elements in which implementations of the present disclosure may be employed;

FIG. 5B illustrates a disruption in a provisioning request from the network provisioning engine of the network elements in which implementations of the present disclosure may be employed;

FIG. 6A illustrates an active hot standby setup from the perspective of a primary network provisioning engine in which implementations of the present disclosure may be employed;

FIG. 6B illustrates an active hot standby setup from the perspective of a secondary network provisioning engine in which implementations of the present disclosure may be employed;

FIG. 7 illustrates an initiation of a failover in which implementations of the present disclosure may be employed;

FIG. 8 illustrates a failover process in which implementations of the present disclosure may be employed;

FIG. 9 illustrates cluster manager rules in which implementations of the present disclosure may be employed; and

FIG. 10 illustrates a flow diagram of a method in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “mmWave” means RF waves having a wavelength measured in millimeters or fractions of millimeters (i.e., less than one cm), generally in the range of 30 GHz – 3 THz, though frequencies above and below that range may still be used by aspects of the present disclosure.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a billing system is a type of brand (e.g., brand, sub-brand, and/or common brand) that provides a billing payload as one or more features with optional attributes of the brand (e.g., a customer plan associated with a telecommunications network). A billing system (e.g., a customer management system) is triggered for any voluntary and/or involuntary transaction (e.g., provisioning transactions) that updates a network profile associated with a customer (e.g., the brand and aspects of the brand associated with the customer) and impacts the services to the customer (e.g., examples of such provisioning transactions may include activation, deactivation, port-in, port-out, update customer profile, update features, suspension, change SIM, change bill cycle, BAN to BAN change, voicemail PIN reset, and more). A network provisioning engine (NPE) is a provisioning system that receives the provisioning transactions from the billing system via one or more middleware platforms. The NPE translates customer facing services (CFSs) (e.g., one or more optional features of a brand, such as international calling, voicemail, SMS service, etc.) that are received from the billing system to network facing services (NFSs) based on a catalog lookup associated with the billing system. The NFSs are translations of the CFSs in a computer readable format, and the NFSs comprise attributes for each network element (e.g., associated with a telecommunications core network, the network elements provide network services). The NPE sends a provisioning request against each network element to ensure customers receive the services associated with brand. In other words, the NPE may provision network nodes to enable customer services. Accordingly, the NPE is at the center of the provisioning flow by provisioning various network elements for various application programming interfaces (APIs) to enable services for customers.

Conventionally, a typical network reactively corrects a partial or full degradation of services included in a customer’s plan. In other words, in case of any out of sync between a billing system and a network, the network often responds to issues in customer services after the issue has occurred, which typically involves troubleshooting and fixing problems as they arise. For example, when one of the network elements is experiencing a disruption, the NPE waits or queues up transactions associated with that network element and waits for the disruption to be resolved. The customer may not have the right or desired services when the customer’s full services are not working properly or there is a partial service degradation. As can be seen, the NPE plays a major role in enabling services for subscribers, but as a consequence of this reactive approach, traffic is often routed from a faulty data center to a healthy data center in an untimely manner, disrupting services to customers for substantial periods of time (e.g., anywhere from seconds to hours). In some examples, active hot standby (AHS) configurations, where an application operates in parallel across two data centers with one serving as the primary site (e.g., until the primary site becomes faulty) and the other as standby (e.g., the healthy data center that takes over for the faulty data center), have become standard practice for achieving high availability and disaster recovery capabilities. Networks have utilized AHS configurations reactively to restart NPE operations at the standby data center, because the transfer to the standby data center only occurs after the first NPE fails entirely. As technology evolves and demands for continuous uptime increases, innovation upon traditional AHS setups is required.

Unlike conventional solutions, the present disclosure is directed to a proactive method of traffic routing. In order to accomplish this, an AHS model is used in conjunction with an NPE in a proactive manner. An inventive aspect described herein is showcased during AHS failover, and specifically pertains to how the NPE resumes an in-progress transaction at the standby site. Another inventive aspect pertains to how the detection and identification of system issues is accomplished in real-time or near real-time and failover is triggered in real-time or near real-time to prevent any customer provisioning issues and to ensure that the NPE is provisioning properly. According to the disclosure described herein, the NPE includes a set of clusters that serve brands. Each NPE cluster includes multiple components (e.g., inbound adapter, orchestrator, outbound adapter, catalog, database, etc.). When components of the clusters are operating properly, the customer receives the full services associated with the brand that is associated with the customer. Every NPE cluster being processed at a first data center is paired up with the same set of NPE clusters (e.g., back-up clusters) at a second data center to ensure that geographic redundancy is maintained. Here, the first data center includes a first NPE and is the primary data center that is active and receives the traffic, and the second data center replicates the first NPE with a second NPE that is held in standby, only to be enabled when it is determined that the first NPE may experience a disruption. In case any of the components within a cluster being processed by the first NPE is determined to fail or potentially fail while processing a transaction, the transaction may resume at the second data center with the second NPE. Because the second data center is synced with the first data center, the second data center may pick up with processing the transaction at the point where the first NPE failed or may have failed. In this way, processing the transaction continues in real-time or near real-time, which contrasts to the delay associated with the reactive approach typically followed by conventional solutions.

Accordingly, a first aspect of the present disclosure is directed to a system for routing traffic to back-up clusters within a wireless communication system. The system comprises one or more cellular network telecommunications functions configured to utilize a first data center and a second data center in an active hot standby (AHS) setup. The system further comprises one or more computer processing components configured to perform operations comprising monitoring a status of a plurality of components within a cluster being processed by the first data center. The operations further comprise detecting a component having a faulty status from the plurality of components. The operations further comprise determining whether the faulty status meets a failover threshold. The operations further comprise triggering the first data center to stop processing the cluster based on a determination that the faulty status meets a failover threshold. The operations further comprise initiating a failover service, wherein the failover service routs the cluster to the second data center to continue processing the cluster.

A second aspect of the present disclosure is directed to a method for routing traffic to back-up clusters within a wireless communication system. The method comprises monitoring a status of a plurality of components within a cluster being processed by a first data center utilized by one or more cellular networks in an active hot standby (AHS) setup. The method further comprises detecting a component having a faulty status from the plurality of components. The method further comprises determining whether the faulty status meets a failover threshold. The method further comprises triggering the first data center to stop processing the cluster based on a determination that the faulty status meets a failover threshold. The method further comprises initiating a failover service, wherein the failover service routs the cluster to a second data center utilized by the one or more cellular networks in the AHS setup to continue processing the cluster.

Another aspect of the present disclosure is directed to a non-transitory computer readable media having instructions stored thereon that, when executed by one or more computer processing components, cause the one or more computer processing components to perform a method for routing traffic to back-up clusters within a wireless communication system. The method comprises monitoring a status of a plurality of components within a cluster being processed by a first data center utilized by one or more cellular networks in an active hot standby (AHS) setup. The method further comprises detecting a component having a faulty status from the plurality of components. The method further comprises determining whether the faulty status meets a failover threshold. The method further comprises triggering the first data center to stop processing the cluster based on a determination that the faulty status meets a failover threshold. The method further comprises initiating a failover service, wherein the failover service routs the cluster to a second data center utilized by the one or more cellular networks in the AHS setup to continue processing the cluster.

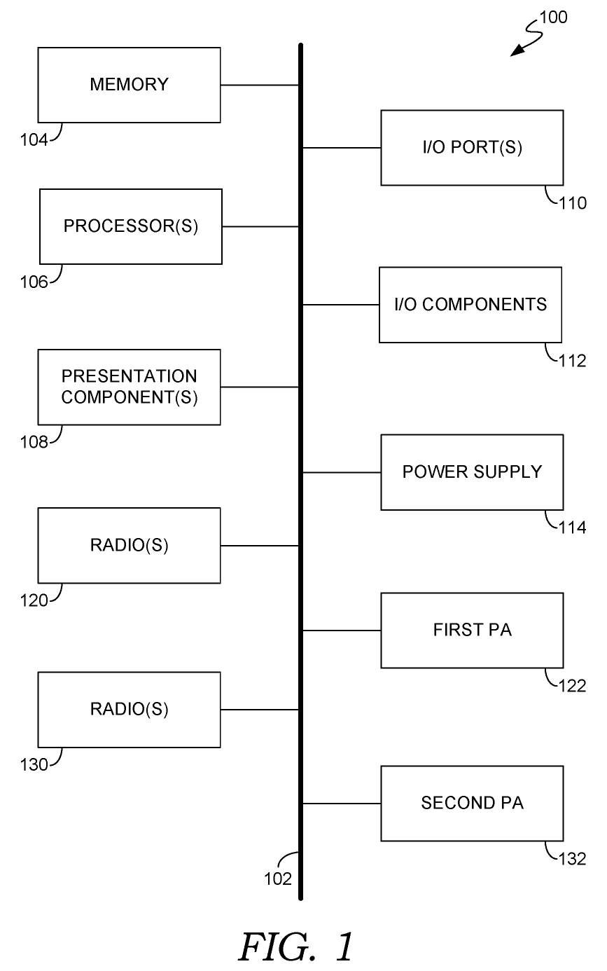

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

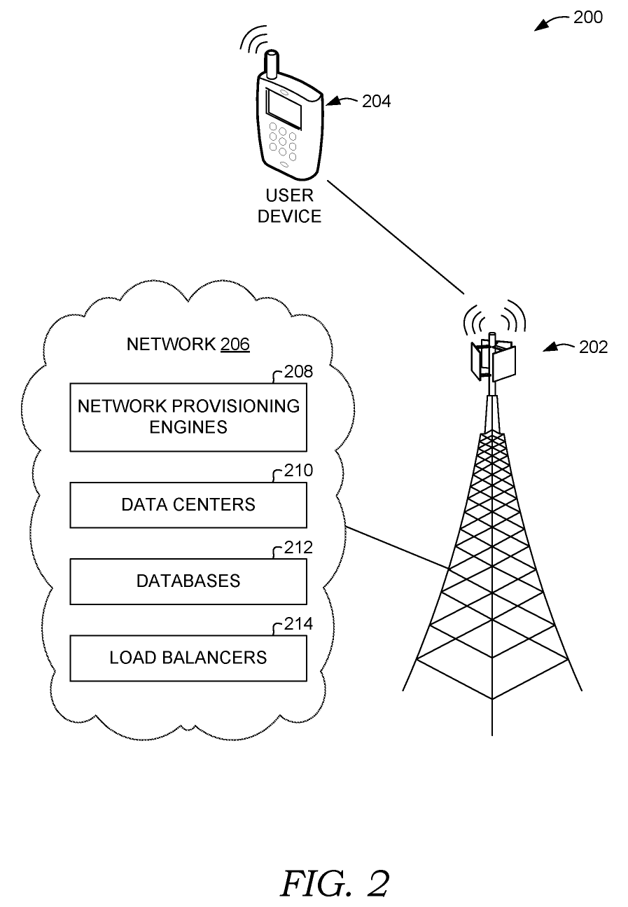

Turning now to FIG. 2, an exemplary network environment is illustrated in which implementations of the present disclosure may be employed. Such a network environment is illustrated and designated generally as network environment 200. At a high level, the network environment 200 comprises one or more UEs, one or more base stations, and one or more networks. Though a UE 204 is illustrated as a cellular phone, a UE suitable for implementations with the present disclosure may be any computing device having any one or more aspects described with respect to FIG. 1. Similarly, though a base station 202 is illustrated as a macro cell on a cell tower, any scale or form of access point acting as a transceiver station for wirelessly communicating with a UE, including small cells, pico cells, Wi-Fi access points (e.g., routers or mesh networks), and the like, are suitable for use with the present disclosure.

The network environment 200 comprises one or more base stations with which a UE may wirelessly communicate. The base station 202 comprises hardware and software components that allow it to wirelessly communicate with one or more UEs in one or more coverage areas. Each coverage area may be logically defined in space and frequency as one or more cells, which may or may not overlap. Using any radio access technology selected by a mobile network operator (e.g., 4G, 5G, 6G, 802.11x, and the like), the base station may transmit and receive wireless signals using one or more antenna elements.

Each base station of the one or more base stations may be associated with one or more at least partially distinct networks, wherein each network is associated with one or more network identifiers. Each network, such as network 206, may be a telecommunications network(s) (e.g., a packet data network or core network), data network, or portions thereof. A telecommunications network that at least partially comprises the network environment 200 may include additional devices or components (e.g., one or more base stations) not shown. Those devices or components may form network environments similar to what is shown in FIG. 2, and may also perform methods in accordance with the present disclosure. Components such as terminals, links, and nodes (as well as other components) may provide connectivity in various implementations.

In order to rout traffic to back-up clusters within a wireless communication system according to the present disclosure, the network environment comprises one or more network provisioning engines 208. Though illustrated as a dedicated engine within a network, the network provisioning engines 208 and its modules are described herein by way of their functionality and may be deployed or implemented in various ways that are consistent with the functionality described herein. For example, the network provisioning engines 208 may take the form of one or more computer processing components at or near the base station 202 executing computer executable instructions that cause the one or more computer processing components to perform the operations described herein. The one or more network provisioning engines 208 may be said to communicate with one or more data centers 210, one or more databases 212, and one or more load balancers 214.

The one or more data centers 210 are configured manage and distribute vast amounts of data critical to telecommunications services. In some aspects, the one or more data centers 210 are utilized in an AHS setup. In some examples, the AHS setup may include an application that operates in parallel across two data centers with one serving as the primary site and the other as standby. The one or more network provisioning engines 208 are hosted on the one or more data centers 210. Serving as a hub for telecommunications networks (e.g., such as the network 206), the one or more data centers 210 facilitate critical telecommunication functions such as routing voice calls, transmitting data, hosting applications, and supporting global connectivity.

The one or more databases 212 are also configured in an AHS setup. In some aspects, the one or more databases 212 comprises one or more internal Cassandra databases. In some embodiments, the one or more databases 212 are synced with data (e.g., data associated with the progress of processing a transaction) in real-time or near real-time. In some examples, the data stored in the one or more databases 212 is structured in the form of tables (e.g., the tables containing transaction queues and current status of a transaction being processed). In some aspects, the data stored in the one or more databases 212 may be structured in the other forms. In some examples, the one or more databases 212 may be stored on the cloud or may be physically stored. For example, the one or more databases 212 may include on-chip storage and/or off-chip storage. The one or more databases 212 may include one or more storage elements including RAM, SRAM, DRAM, VRAM, Flash, hard disks, and/or other components and/or devices that may store at least one bit of data.

The one or more load balances 214 are configured to distribute incoming network traffic across multiple servers or network resources. In some examples, the one or more load balancers 214 facilitates the switch from the primary site to the standby site in the AHS setup. In some embodiments, the one or more load balancers 214 may be configured to optimize resource utilization, maximize throughput, minimize response time, and avoid overloading any single server or network element. In some aspects, the one or more load balancers 214 may operate at the application layer of the Open Systems Interconnection model and can manage various types of traffic, including HTTP, HTTPS, TCP, UDP, and more.

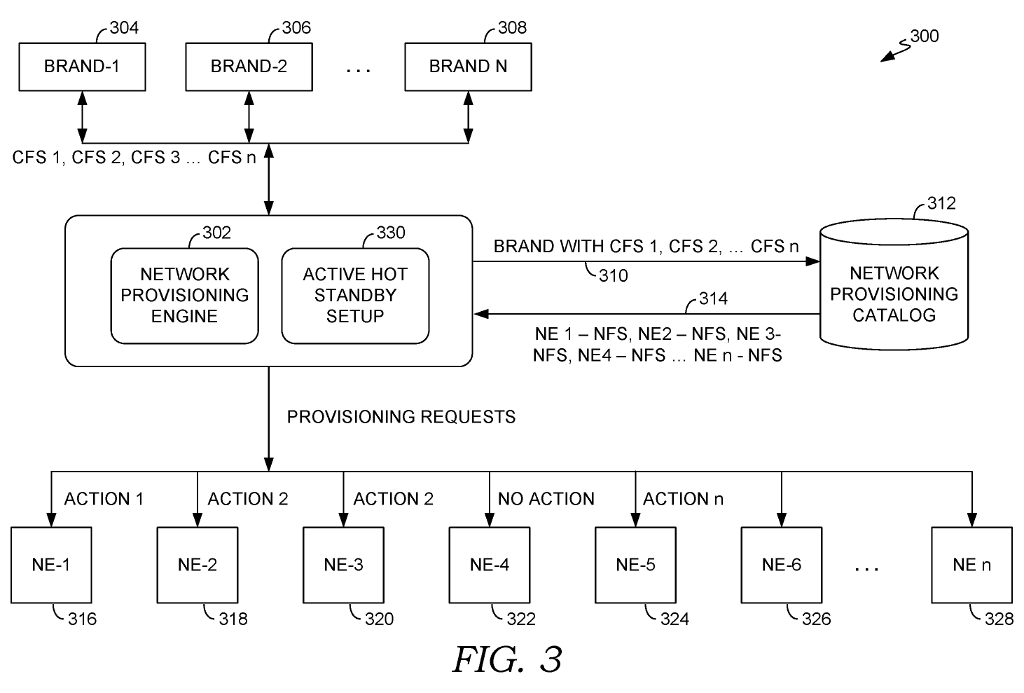

Turning now to FIG. 3, an example of a network provisioning system 300 is provided. The network provisioning system 300 illustrates an NPE 302 in which implementations of the present disclosure may be employed. The network provisioning system 300 visually represents an example of a provisioning system that receives provisioning transactions from a billing system (e.g., a customer management system). For example, a billing system, which maintains a customer's profile, may initiate one or more provisioning requests by sending a list of current features in a billing payload as one or more features associated with a brand, such as a Brand-1 304, a Brand-2 306, and so on until a Brand n 308. In the example illustrated in FIG. 3, the NPE 302 receives the provisioning transactions from the billing system, including the list of current features in the billing payload, which contains CFS 1, CFS 2, CFS 3, and so on until CFS n. The CFSs are one or more optional features of a brand (e.g., such as international calling, voicemail, SMS service, etc.).

In some aspects, the NPE 302 converts the list of CFSs into NFSs. The NFSs are translations of the CFSs in a computer readable format, and the NFSs comprise attributes for each network element. The NPE 302 translates the list of CFSs into NFSs based on a specific conversion catalogue, a network provisioning catalog 312. In some embodiments, each brand is associated with a distinct conversion catalogue that is specific to that brand. As such, Brand-1 304 may be associated with a catalog that is different than the catalog associated with Brand-2 306, for example. In the embodiment depicted in FIG. 3, the NPE 302 sends the CFSs associated with a brand (i.e., the brand with CFS 1, CFS 2, and so on until CFS n) to the network provisioning catalog 312 (e.g., represented by arrow 310) to translate the CFSs into NFSs. In this example embodiment, the network provisioning catalog 312 converts the CFSs into NFSs and sends them back to the NPE 302 (e.g., represented by arrow 314). In some examples, the NPE 302 sends provisioning requests (e.g., action 1, action 2, action 3, no action, and/or action n) against each network element (e.g., represented in FIG. 3 in an abbreviated form as NE-1 316, NE-2 318, NE-3 320, NE-4 322, NE-5 324, NE-6 326, and so on until an NE n 328). An AHS setup 330 is used in conjunction with the NPE 302 to ensure that the provisioning requests are processed with little to no service degradation.

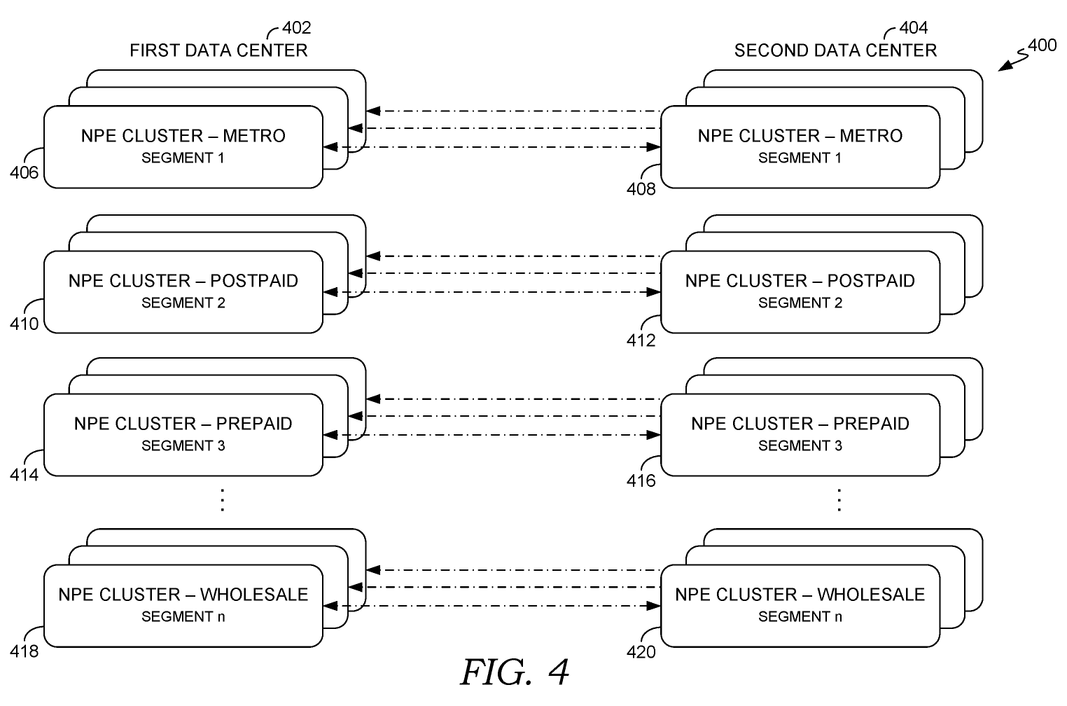

Turning now to FIG. 4, an example of NPE cluster segments 400 is provided. In some aspects, the NPE 302 includes sets of clusters (e.g., segments) deployed for each brand (e.g., for each telecommunications network plan). In other words, each of the NPE clusters are associated with a brand, and every brand includes several clusters associated with that brand. In some embodiments, each set of clusters may be stored and/or processed in a first data center and may be paired with an equivalent set of clusters in a second data center. For example, in the example embodiment depicted in FIG. 4, a first data center 402 is associated with at least four sets of clusters (e.g., metro 406, postpaid 410, prepaid 414, and wholesale 418), and a second data center 404 is associated with at least four sets of clusters (e.g., metro 408, postpaid 410, prepaid 414, and wholesale 418) that are duplicates of the at least four sets of clusters being stored and/or processed by the first data center 402. In some aspects, each set of the clusters may be maintained at the first data center 402 and may be paired up in real-time or near real-time with an equivalent set of clusters that is maintained at the second data center 404 in order to make sure that geographical redundancy is maintained. In the example embodiment depicted in FIG. 4, the first data center 402 may be primary to receive traffic and will be the active data center unless a component is determined to potentially be faulty, in which case the cluster sets maintained in “hot standby” at the second data center 404 will be enabled.

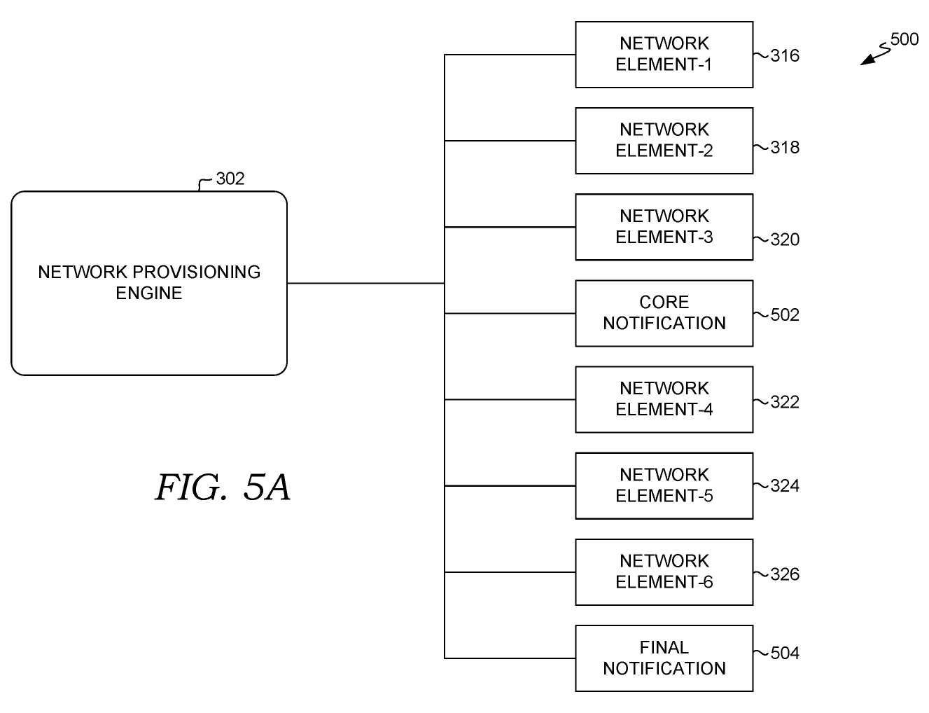

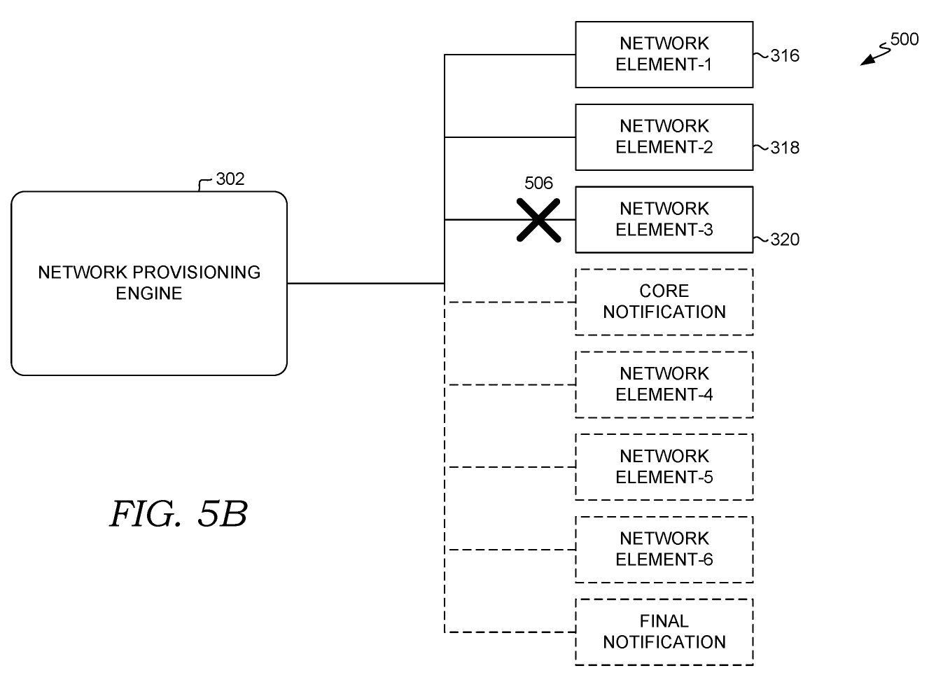

Referring now to FIGS. 5A and 5B, example provisioning requests 500 are illustrated. FIG. 5A illustrates provisioning requests from the NPE 302 of network elements (e.g., the network element-1 316, the network element-2 318, the network element-3 320, the network element-4 322, the network element-5 324, the network element-6 326, and so on until the network element n 328). In some embodiments, the NPE 302 triggers provisioning requests to some network elements in parallel. In some aspects, the NPE 302 triggers provisioning requests to some network elements in a sequential order. For example, when a provisioning request is received, the network elements may be processed and satisfied sequentially (e.g., 1, 2, 3, and so on). These network elements are core network elements of a core central network (e.g., not pictured). When a certain amount of network elements are satisfied, the core central network receives a core notification 502. In some examples, once the core notification 502 is received, a customer may register a UE (e.g., such as the UE 204) on the network, and once the UE is registered, the UE may experience other auxiliary systems. In other words, when the NPE 302 triggers provisioning requests, the NPE 302 creates a few network elements, then the NPE 302 triggers a notification (e.g., the core notification 502) to be sent back upstream to notify the core central network that the customer’s first provisioning is done (e.g., creation of the core central network).

In some aspects, the NPE 302 may continue to send provisioning requests until the core network receives a final notification 504. For example, the NPE 302 my provision all of the network elements to achieve the entire registration of a service to a network. In some examples, about 15 to 20 network elements are provisioned to achieve the entire registration of a service to a network, and the entire registration process may take about 20 seconds, unless the network element is down or some other type of disruption occurs. In some aspects, disruptions to a customer’s services can be caused by the occurrence of the following incidents: geographical disasters; Cassandra (database) failures; choked clusters due to excessive traffic; southbound network elements issues; performance issues with the NPE, which causes degradation; incorrect configurations; issues due to changes/upgrades; defects/bugs; hardware failures; API micro services going down due to memory leaks and/or lack of memory; an NPE cluster reaching its limit; Orchestration Module failures; an exhausted network element retry; and/or an error retry threshold is reached.

When one or more of the network elements experiences a disruption during the provisioning process, a conventional NPE waits or queues up the transaction associated with the network element and waits for that particular network element to come up, at which point the conventional NPE will request provisioning of that network element again. For example, if the voicemail server is down due to scheduled maintenance, the conventional NPE queues up the transaction for this request and waits for the voicemail server to come back up. Once the voicemail server comes back up, the transaction is released and the customer gets the voicemail service.

In contrast to a conventional NPE that waits or queues up a transaction, the current disclosure utilizes an AHS setup to address a potential disruption in real-time or near-real time, without the typical waiting period associated with a conventional NPE. In other words, when any of the components within a set of clusters included in the NPE fails while processing a transaction, the transaction automatically resumes from a different data center in real-time or near-real time. For example, FIG. 5B depicts a failure 506 associated with the NPE failing while processing the network element-3 320. In this example, when the NPE fails while processing the network element-3 320, the customer only gets services until the point where the network element-3 320 goes down, at which point the present disclosure initiates failover. Failover means that in order for this particular provisioning to continue in real-time or near real-time, the provisioning should resume from the other side in an AHS setup. As such, according to the present disclosure, the transaction may be resumed at a different data center starting from the point where the NPE failed while processing the network element. Accordingly, the transaction switches from a primary (e.g., active) data center to a different data center—the hot standby—and completes the transaction from that data center. In some aspects, the hot standby data center only becomes active when the primary data center does down, which is the essence of the AHS setup.

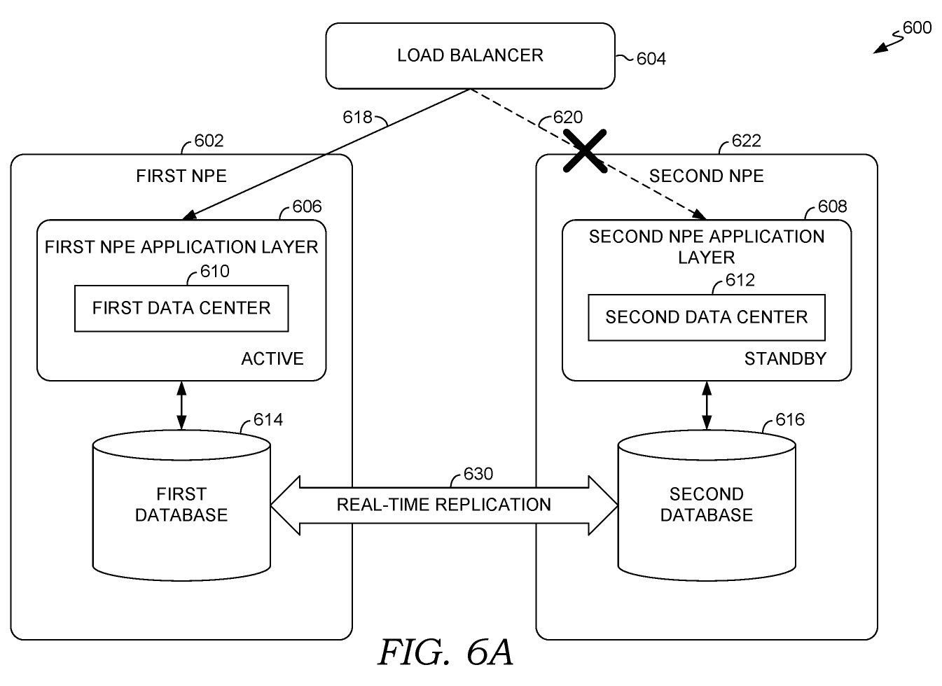

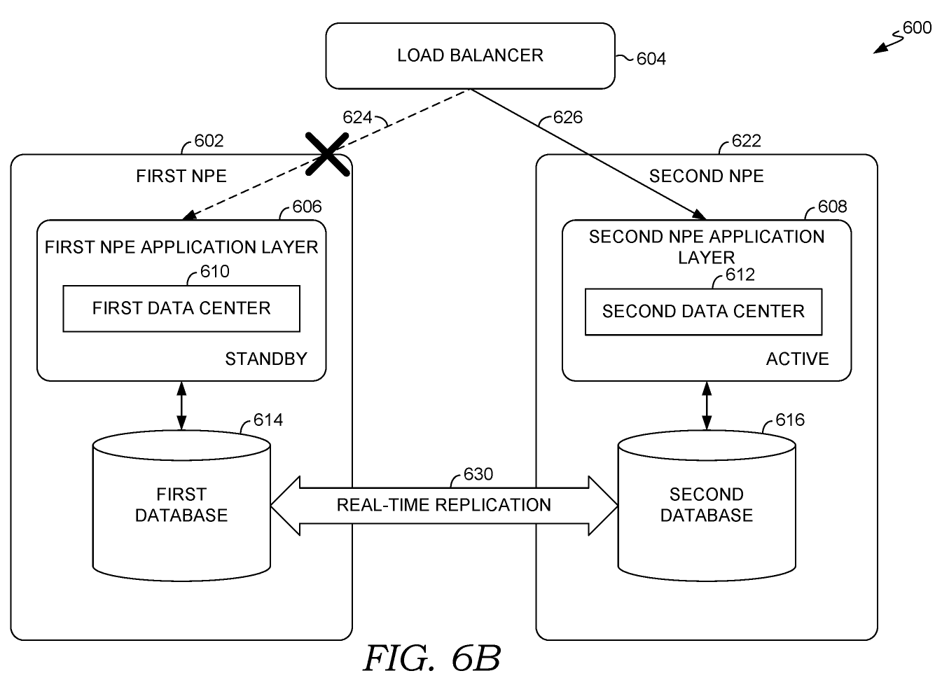

Turning now to FIGS. 6A and 6B, an example of an AHS setup 600 is provided. In some aspects, the AHS setup 600 includes a load balancer 604 and two NPEs: a first NPE 602 and a second NPE 622. In some examples, the load balancer 604 is configured to distribute incoming network traffic across both NPEs. For example, the load balancer 604 distributes the network elements to an NPE to process the network elements. In some aspects, the load balancer 604 facilitates the switch from the primary site (e.g., the first NPE 602) to the standby site (e.g., the second NPE 622) in the AHS setup 600.

FIG. 6A illustrates an AHS setup from the perspective of the first NPE 602, the primary (e.g., active) NPE. In this example, the load balancer 604 distributes incoming network traffic to the first NPE 602 (e.g., illustrated by arrow 618). In some aspects, the first NPE 602 includes a first NPE application layer 606, a first data center 610, and a first database 614. The first NPE application layer 606 of the first NPE 602 is where the first NPE 602 processes transactions at the first data center 610. In the example illustrated in FIG. 6A, the load balancer 604 is not distributing incoming network traffic to the second NPE 622 (e.g., illustrated by the dashed arrow 620), because the first NPE 602 is active while the second NPE 622 is standby. In some embodiments, as the first NPE 602 actively processes transactions in real-time or near-real time, the progress of processing a transaction (e.g., a network element) is stored in the first database 614 (e.g., a Cassandra database). In case the first NPE 602 experiences a disruption, the progress of processing the transaction is not only stored in the first database 614, but also the progress of processing the transaction is similarly stored in a second database 616 (e.g., as indicated by the double arrow 630), which is associated with the second NPE 622. For example, the data replication of the first database 614 is shared with the second database 616 in real-time or near real-time (e.g., 40-50 millisecond delay, in some examples) such that the data is synchronized between the two databases, enabling the second data center 612 to continue where the first data center 610 left off. The load balancer 604 may continue to distribute incoming network traffic to the first NPE 602 until the first NPE 602 fails or is likely to fail while processing a transaction.

FIG. 6B illustrates the AHS setup 600 from the perspective of the standby site, the second NPE 622. In this example, the first NPE 602 has failed, or it has been determined that the first NPE 602 is likely to fail, while processing a transaction. Because the progress of the transaction (e.g., where the first NPE 602 failed) is stored in the second data center 612 of the second NPE 622, the second NPE 622 may pick up from the point where the first NPE 602 left off, from where the first NPE 602 failed while processing the transaction. As such, the load balancer 604 ceases to distribute traffic to the first NPE 602 (e.g., illustrated by dashed arrow 624), and instead begins to distribute traffic to the second NPE 622 (e.g., illustrated by arrow 626). Accordingly, the second NPE begins to process the transaction with a second NPE application layer 608 that is used by the second NPE 622 to process the transaction (e.g., and further transactions, in some examples) at a second data center 612.

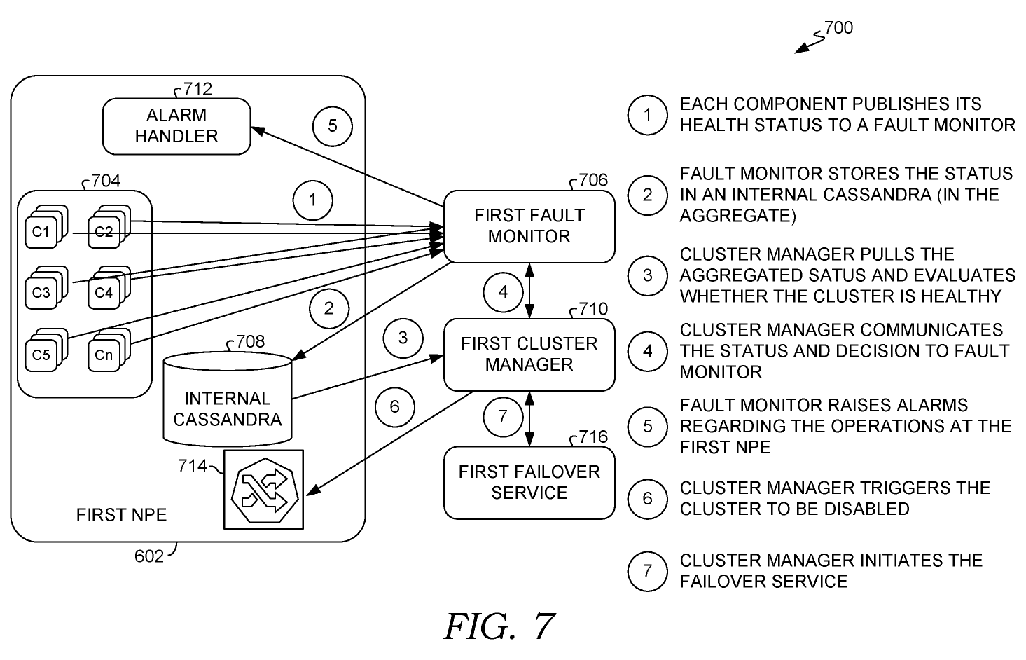

Turning now to FIG. 7, FIG. 7 illustrates an initiation of a failover 700. In the example embodiment depicted in FIG. 7, the first NPE 602 houses a first cluster 704, which is one cluster of a cluster set. Each set includes multiple NPE clusters that serve business segments (e.g., different brands). As such, the first cluster 704 is a service cluster associated with a brand. The first cluster 704 includes several components (e.g., C1, C2, C3, C4, C5, and so on until Cn). In some examples, the components include an inbound adapter, orchestrator, outbound adapter, catalog, database, and any other service related to a brand.

The initiation of the failover 700 includes several steps. First, each component in the first cluster 704 may individually publish its health status to a first fault monitor 706. For example, the component may report whether it is healthy or not. As such, in some aspects, each individual component has a mechanism that monitors the health status of that specific component. When components of the clusters are operating properly (e.g., are healthy), the customer receives the full services associated with the brand associated with that customer. Each component of the first cluster 704 publishes its health status to the first fault monitor 706 every specified interval, and the interval is configurable (e.g., every 10 seconds, every 30 seconds, every minute, every two minutes, or any other time interval). The first fault monitor 706 stores the information regarding the health status of each component into an internal Cassandra 708 (i.e., database), and the internal Cassandra 708 stores the health status of each component in the aggregate. In other words, the first fault monitor 706 generates the health status of each component and stores it to the internal Cassandra 708. For example, the first fault monitor 706 may receive information from C1 that reports C1 is healthy (e.g., functioning properly) at 10:02 AM, and that information is stored in the internal Cassandra 708. In another example, at 10:03 AM, C5 publishes to the first fault monitor 706 that it is not healthy, and that information is also stored in the internal Cassandra 708. As such, the internal Cassandra 708 stored aggregated data regarding the status of each component.

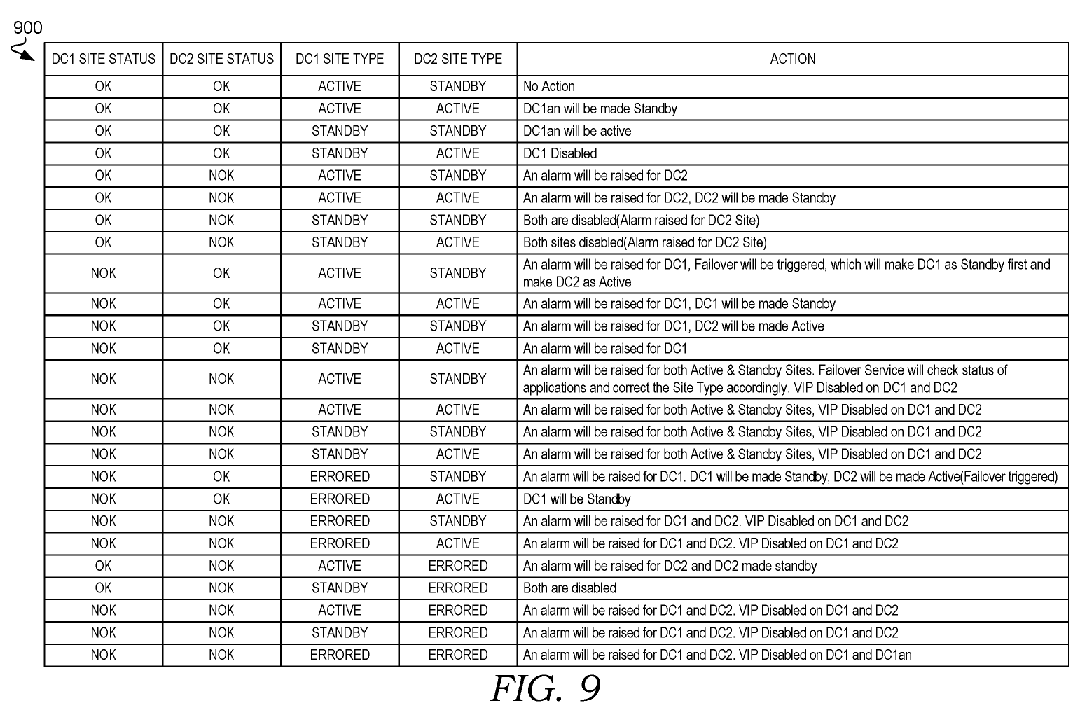

A first cluster manager 710 pulls the aggregated status of each component from the internal Cassandra 708 and evaluates whether the cluster is actually healthy or not (e.g., EDA-P cluster module’s status). In some aspects, the first cluster manager 710 is where the failover rules are defined (e.g., see FIG. 9 for an overview of example failover rules). As such, triggering failover comprises referencing one or more failover rules. Referencing its internal, decision-making rules system, and based on a threshold value of how many clusters are failing or might fail (e.g., based on a percentage), the first cluster manager 710 will determine whether any actions are required. In other words, the first cluster manager 710 evaluates each and every cluster (e.g., based on the status of the components of the cluster) to determine whether the cluster is faulty (e.g., failover should be initiated) or whether the first cluster 704 is safe to continue to be processed by the first NPE 602. For example, in evaluating the overall health of a cluster, the first cluster manager 710 will process the health status of each cluster and will apply a configurable failover threshold to each cluster. In some examples, the failover threshold that is applied is a percentage of availability. For example, if more than 66% of components within a cluster are healthy and operating properly, then failover is not initiated. In contrast, if less than 66% of components are healthy, then failover is initiated. In some examples, the first cluster manager 710 will double or triple check the health status of the components before determining that failover should be initiated. In some embodiments, if a cluster (e.g., or one or more of the components therein) fail to be replicated to the standby data center, then that may also be a threshold indicator that failover should be initiated.

If the first cluster manager 710 determines that the first cluster 704 is faulty and that failover should be initiated, the first cluster manager 710 communicates the faulty status and the decision to initiate failover to the first fault monitor 706. The first fault monitor 706 raises alarms regarding the operations at the first NPE 602, which effectively begins the failover process. In some aspects, the first fault monitor 706 raises the alarms when the first cluster manager 710 is not available. In some examples, an alarm handler 712 receives the alarm from the first fault monitor 706, and the alarm handler 712 sends an alert to a network operations engineer that something is not operating properly with the first cluster 704 at the first NPE 602, and that something should be done to correct the operations of the first NPE 602. After the first fault monitor 706 raises alarms, the first cluster manager 710 triggers the cluster to be disabled at an ingress service 714 (e.g., the load balancer 604 stops distributing incoming network traffic to the first NPE 602). As such, the first cluster manager 710 relays the faulty cluster health to a first failover service 716, and the first failover service 716 initiates the failover process.

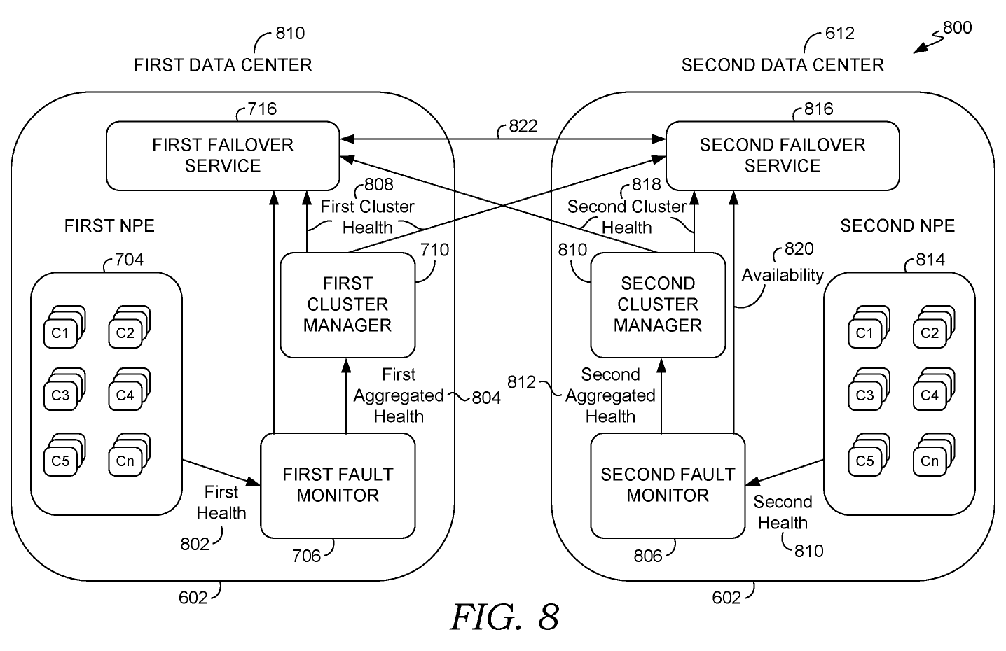

With reference now to FIG. 8, an example failover process 800 is illustrated. Before the failover process 800 is initiated (e.g., before a disruption occurs and failover is triggered), the first data center 610 is keeping up with the network elements that are being fulfilled. However, after the failover process is initiated (e.g., after disruption occurs, failover is triggered), the first data center 610 goes down, and the second data center 612 (e.g., the AHS data center, the failover server) begins to work, starting at the point where the first data center 610 left off, because the first data center 610 already transferred the information regarding where it left off to the second data center 612 (e.g., the backup cluster or the geographical redundancy site). Accordingly, the failover process is a step-by-step process. On the side that was active but turned to standby (e.g., the first data center 610 and the first NPE 602), the traffic is stopped and database permissions are revoked. On the side that was standby but turned to active (e.g., the second data center 612 and the second NPE 622), traffic is enabled and database permissions are granted. Accordingly, when the failover service is initiated, the first NPE 602 is no longer in service, and operations are switched to the second NPE 622 and to the second data center 612.

In some aspects, the first failover service 716, operating within the first NPE 602, may evaluate the health status of the first cluster 704 received from the first fault monitor 706 (e.g., a first health 802) and/or from the first cluster manager 710 (e.g., a first cluster health 808 based on a first aggregated health 804). Similarly, in some aspects, a second failover service 816, operating within the second NPE 622, may evaluate the health status of a second cluster 814 (e.g., identical to the first cluster 704) received from a second fault monitor 806 (e.g., a second health 824) and/or a second cluster manager 810 (e.g., a second cluster health 818 based on a second aggregated health 812). As such, the faulty status associated with the first data center 610 is communicated to the second data center 612. In some aspects, both data centers communicate to one another to report the status of each data center (e.g., whether the data center is operating properly or whether the initiation of failover is anticipated at the standby data center) so that traffic may be routed to a healthy data center.

In some examples, the first failover service 716 may sync-up with the second failover service 816 to make a decision regarding whether to trigger the failover process at the second data center 612 (e.g., illustrated by the double arrow 822). For example, before traffic can be switched from the first data center 610 and the first NPE 602 to the second data center 612 and the second NPE 622, the second fault monitor 806 must determine whether the second NPE 622 is even capable of processing the second cluster 814. In other words, the second fault monitor 806, working with the second cluster manager 810 (e.g., similar to the operations of the first fault monitor 706 and the first cluster manager 710), determines an availability 820. If the second NPE 622 is capable of processing the second cluster 814 without issue (e.g., none of the components are failing or are likely to fail), then no alarms are raised and the second NPE 622 is available. In contrast, if the operations of the second NPE 622 are also faulty, then the traffic should be switched from the first data center 610 to a different data center, because the second data center 612 is not in a position to pick up where the first data center 610 left off. For example, if something fails at a particular cluster at the second data center 612 (e.g., if a component becomes faulty, for example), and the traffic were to go from the first data center 610 to the second data center 612 (e.g., the second data center 612 goes from standby to active, rendering the first data center 610 as standby), there would be no mechanism that automatically switches the service back to the first data center 610. Instead, if there is an issue at both data centers, a logic exists in the system that takes the information from both clusters (e.g., the first cluster 704 and the second cluster 814) from the rotation and sends the traffic to another backup cluster (e.g., within a third data center) to solve the traffic and to continue processing the cluster.

Turning now to FIG. 9, examples of cluster manager rules are depicted. The cluster manager rules are failover rules. FIG. 9 includes a chart that describes various use cases (e.g., rules) that a cluster manager (e.g., the first cluster manager 710 and/or the second cluster manager 810) references in its decision-making process to determine whether the components of a cluster (e.g., and the cluster as a whole) is healthy or not. For example, the failover rules may be used by a cluster manager to trigger a first data center to stop processing a cluster when a failover threshold is met. In some aspects, a cluster manager may identify a site type and a site status of a cluster on which it’s running. Notably, the site type is sent as part of the notification to the failover service. In the example embodiment depicted in FIG. 9, site type can include the following values: active, standby, and/or errored (e.g., an error exists). These terms are relative and any other terms may be used that convey the same meaning. In the example embodiment depicted in FIG. 9, the site status can be the following values: OK (e.g., okay), NOK (e.g., not okay), and/or UNKNOWN. Again, these terms are relative and any other terms may be used that convey the same or similar meaning. In general, FIG. 9 depicts the rules that a cluster manager follows. As such, the cluster manager is a rule-based model.

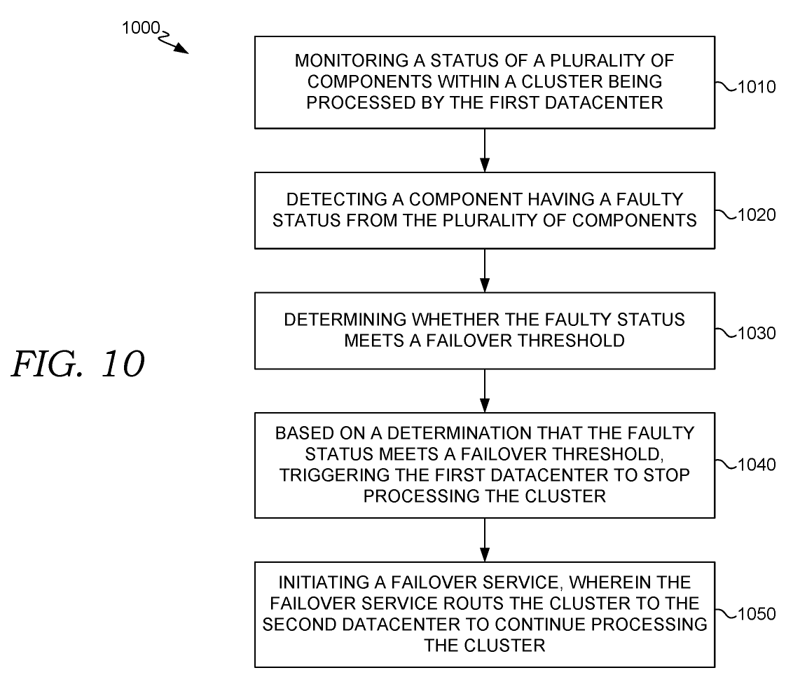

Turning now to FIG. 10, a flow chart representing a method 1000 is provided. Generally the method 1000 may be used by a network, such as the network 206 of FIG. 2, to route traffic to back-up clusters within a wireless communication system. At a first step 1010, the network monitors a status of a plurality of components within a cluster being processed by a first data center utilized by one or more cellular networks in an active hot standby (AHS) setup, according to any one or more aspects described with respect to FIGS. 2-9. At a second step 1020, the network detects a component having a faulty status from the plurality of components, according to any one or more aspects described with respect to FIGS. 2-9. At a third step 1030, the network determines whether the faulty status meets a failover threshold, according to any one or more aspects described with respect to FIGS. 2-9. At a fourth step 1040, the network triggers the first data center to stop processing the cluster based on a determination that the faulty status meets a failover threshold, according to any one or more aspects described with respect to FIGS. 2-9. At a fifth step 1050, the network initiates a failover service, wherein the failover service routs the cluster to a second data center utilized by the one or more cellular networks in the AHS setup to continue processing the cluster, according to any one or more aspects described with respect to FIGS. 2-9.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for routing traffic to back-up clusters within a wireless communication system, the system comprising:
one or more cellular network telecommunications functions configured to utilize a first data center and a second data center in an active hot standby (AHS) setup; and
one or more computer processing components configured to perform operations comprising:
monitoring a status of a plurality of components within a cluster being processed by the first data center;
detecting a component having a faulty status from the plurality of components;
determining whether the faulty status meets a failover threshold;
based on a determination that the faulty status meets a failover threshold, triggering the first data center to stop processing the cluster; and
initiating a failover service, wherein the failover service routs the cluster to the second data center to continue processing the cluster.

2. The system of claim 1, wherein monitoring the status of the plurality of components comprises storing the status of the plurality of components in a database in near real-time.

3. The system of claim 2, wherein the database stores aggregated data regarding the status of each component of the plurality of components.

4. The system of claim 2, wherein the database is an internal Cassandra database.

5. The system of claim 1, wherein determining whether the faulty status meets a failover threshold comprises applying a configurable threshold to the component.

6. The system of claim 5, wherein the faulty status is communicated to the second data center when the failover threshold is met.

7. The system of claim 5, wherein triggering the first data center to stop processing the cluster comprises referencing one or more failover rules.

8. The system of claim 7, wherein the one or more failover rules triggers the first data center to stop processing the cluster when the failover threshold is met.

9. The system of claim 1, wherein the failover service receives the status of the plurality of components once every configurable time interval.

10. The system of claim 9, wherein the failover service routs the cluster to a third data center to continue processing the cluster.

11. A method for routing traffic to back-up clusters within a wireless communication system, the method comprising:
monitoring a status of a plurality of components within a cluster being processed by a first data center utilized by one or more cellular networks in an active hot standby (AHS) setup;
detecting a component having a faulty status from the plurality of components;
determining whether the faulty status meets a failover threshold;
based on a determination that the faulty status meets a failover threshold, triggering the first data center to stop processing the cluster; and
initiating a failover service, wherein the failover service routs the cluster to a second data center utilized by the one or more cellular networks in the AHS setup to continue processing the cluster.

12. The method of claim 11, wherein monitoring the status of the plurality of components comprises storing the status of the plurality of components in a database in near real-time.

13. The method of claim 12, wherein the database stores aggregated data regarding the status of each component of the plurality of components.

14. The method of claim 12, wherein the database is an internal Cassandra database.

15. The method of claim 11, wherein determining whether the faulty status meets a failover threshold comprises applying a configurable threshold to the component.

16. The method of claim 15, wherein the faulty status is communicated to the second data center when the failover threshold is met.

17. The method of claim 15, wherein triggering the first data center to stop processing the cluster comprises referencing one or more failover rules.

18. The method of claim 17, wherein the one or more failover rules triggers the first data center to stop processing the cluster when the failover threshold is met.

19. The method of claim 11, wherein the failover service receives the status of the plurality of components once every configurable time interval.

20. A non-transitory computer readable media having instructions stored thereon that, when executed by one or more computer processing components, cause the one or more computer processing components to perform a method for routing traffic to back-up clusters within a wireless communication system, the method comprising:
monitoring a status of a plurality of components within a cluster being processed by a first data center utilized by one or more cellular networks in an active hot standby (AHS) setup;
detecting a component having a faulty status from the plurality of components;
determining whether the faulty status meets a failover threshold;
based on a determination that the faulty status meets a failover threshold, triggering the first data center to stop processing the cluster; and
initiating a failover service, wherein the failover service routs the cluster to a second data center utilized by the one or more cellular networks in the AHS setup to continue processing the cluster.
